(19) United States
(12) Patent Application Publication
(10) Pub. No.: US 2017/0161752 A1
(43) Pub. Date: Jun. 8, 2017

(54) INCORPORATING REAL-TIME FEEDBACK FROM APPLIANCE SERVICERS INTO AN ELECTRONIC RESOURCE FOR GUIDING APPLIANCE SERVICING

(71) Applicant: Emerson Electric Co., St. Louis, MO (US)

(72) Inventor: Rishi Siravuri, Maryland Heights, MO (US)

(21) Appl. No.: 14/960,106

(22) Filed: Dec. 4, 2015

(51) Int. Cl. G06Q 30/00

(52) U.S. Cl. CPC G06Q 30/016

(57) ABSTRACT

Disclosed are exemplary embodiments of systems and methods for using real-time feedback from appliance servicers. In an exemplary embodiment, a system generally includes a repository in which instructions are stored to provide an interactive resource for guiding user servicing of appliances. Specific appliances are registered in an appliance registry and associated with specific users. Each registered appliance is user-serviceable in accordance with instructions from the repository provided via a server on a display and/or speaker of an intermediary computing device, e.g., a user smart phone. The server solicits and receives, in the course of servicing being user-performed, real-time user feedback pertaining to the servicing instructions. The instructions may be updated in the repository based on the user feedback.

### FIELD

The present disclosure generally relates to appliances, and more particularly (but not exclusively) to incorporating real-time feedback from appliance servicers into an interactive resource for guiding appliance servicing.

### BACKGROUND

This section provides background information related to the present disclosure which is not necessarily prior art.

When installing and/or performing maintenance on home appliances such as heaters, air conditioners, etc., homeowners and installers typically rely on written instructions provided with the appliance by the appliance manufacturer or other supplier.

### DRAWINGS

The drawings described herein are for illustrative purposes only of selected embodiments and not all possible implementations, and are not intended to limit the scope of the present disclosure.

FIG. 1 is a diagram of a system for use by a supplier of and users of a group of appliances in accordance with one example embodiment; and

FIGS. 2 and 3 are flow diagrams of methods of providing interactive guidance for servicing appliances in accordance with example embodiments.

Corresponding reference numerals indicate corresponding parts throughout the several views of the drawings.

### DETAILED DESCRIPTION

Example embodiments will now be described more fully with reference to the accompanying drawings.

The inventors hereof have observed that do-it-yourself (DIY) homeowners and other appliance users typically must use manufacturer instruction sheets in order to be able to install and/or configure a new appliance such as a thermostat. If a user loses the instruction sheet, the user generally must access the manufacturer website, look up a specific model number, and print another copy of the instruction sheet or get other assistance for installing and/or configuring the new product. The inventors also have recognized that an appliance manufacturer typically has to think through the various settings that the manufacturer wishes to offer in a family of products and determine a way to organize the settings for a product so that it is easy for contractors and homeowners to install the product. Manufacturers strive to write instruction sheets describing such settings, and how to set them, so that it would be easy for even a novice installer/homeowner to understand and follow them.

Even after having decided how to describe settings and other product details, and having described them in instruction sheets, the manufacturer typically must throw away all existing instruction sheets and replace them if a product setting or other feature is added or changed. If a user refers to an outdated instruction sheet, or if the instructions are difficult to understand, the user may be forced to call customer service. Such calls can result in a recurring cost for a manufacturer and a waste of time for the manufacturer and the user. Further, a user who is in the process of installing or otherwise servicing an appliance can encounter instructions that are unclear, but not so unclear that they prevent the user from completing the servicing. Users who have successfully finished servicing an appliance often are unlikely to inform customer service about an instruction that caused merely minor confusion or inconvenience. The manufacturer, then, may have no way to find out that there is room for improving the instructions.

Accordingly, the inventors have developed and disclose herein exemplary embodiments of an apparatus for use by a supplier of and users of a group of appliances. The apparatus includes an information repository residing on at least one computer and in which appliance servicing instructions for servicing the group of appliances are stored to provide an interactive resource for guiding user servicing of any appliance of the group of appliances. A server is configured to communicate with users of the appliances via intermediary computing devices. An appliance registry resides on at least one computer. In the registry, specific appliances in the group of appliances are registered and associated with specific users. Each specific registered appliance is user-serviceable in accordance with appliance servicing instructions from the information repository and provided via the server on a display and/or through a speaker of one of the intermediary computing devices. The server is further configured to solicit and receive, from one of the intermediary computing devices, real-time user feedback pertaining to one or more of the servicing instructions sent to the one of the intermediary computing devices. The feedback is received in the course of servicing being user-performed for one of the specific registered appliances. The appliance servicing instructions are updatable in the information repository based on the user feedback.

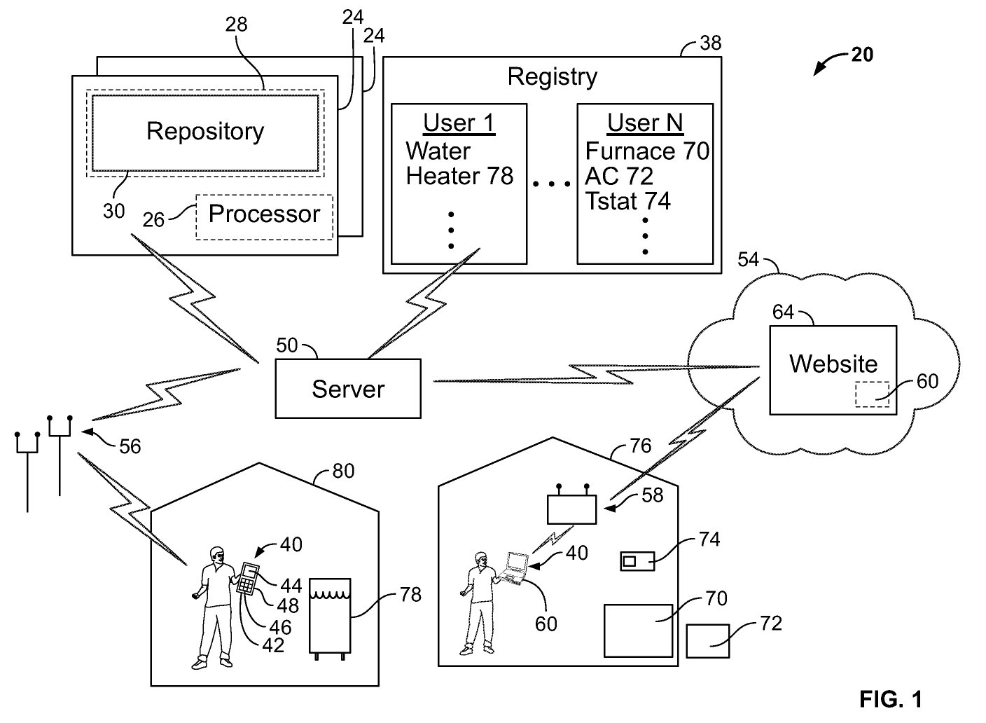

With reference now to the figures, FIG. 1 illustrates an exemplary embodiment of a system 20 embodying one or more aspects of the present disclosure. The example system 20 is maintained, e.g., by a manufacturer and/or supplier of various appliances and is made available to users of the appliances. Such appliances may include, but are not necessarily limited to, climate control appliances, heating appliances, cooling appliances, refrigeration equipment, etc. For simplicity, a manufacturer, supplier or other provider of a system such as the system 20 shall be referred to herein and in the claims as a “supplier.”

The system 20 includes one or more computers 24 having a processor 26 and memory 28 in which an information repository 30 resides. One or more of the computer(s) 24 may be remote from other computer(s) 24, e.g., cloud-based. The repository 30 stores information, including but not necessarily limited to servicing information, relating to appliances, pieces of equipment, devices, etc. made and/or otherwise made available by the supplier. In the present example embodiment, the repository 30 includes appliance information for various thermostats, furnaces, air conditioners, water heaters, igniters, ignition controls, cooling controls, defrost controls, furnace controls, gas valves, heat pumps, etc. For simplicity, and unless otherwise indicated in the present disclosure and claims, an appliance, a piece of equipment, a device, and/or the like may be referred to in the disclosure and claims as an “appliance.” In various embodiments, it is possible for one “appliance” to be a component of another “appliance” provided by a supplier. For example, a supplier may provide water heaters that include gas valves, and also may provide gas valves, e.g., as replacement parts for installation in water heaters.

In the present example embodiment, the repository 30 is a generally comprehensive and up-to-date information source maintained by the supplier, e.g., for providing information to users, including but not necessarily limited to appliance installers and/or appliance owners, about servicing the various appliances provided by the supplier. In some embodiments, the information repository 30 includes appliance servicing information and instructions for substantially every appliance provided by the supplier. Unless otherwise indicated in the present disclosure and claims, “servicing” an appliance includes (without limitation) installing, configuring, providing settings for, operating, diagnosing, and/or maintaining the appliance.

In various embodiments, an appliance registry 38 is resident on the computer(s) 24. The registry 38 is accessible by users, e.g., homeowners and/or installers, of appliances provided by the supplier. For example, various users who have obtained one or more appliances provided by the supplier may register the appliances in the registry 38. Users may register specific appliances in the registry 38 in order to have access to the appliance servicing information and instructions in the information repository 30 for those specific appliances. The registry 38 associates a user who registered specific appliance(s) with each of those specific registered appliances. In various embodiments, the system 20 makes available to the user, for each registered appliance, a library of servicing instructions, settings selected by the user, and other information specific to that appliance. Such information may be provided in a language specified by the user. It should be noted generally that although more than one computer 24 is shown in FIG. 1, various components of the system 20 could reside on the same computer 24 or different computers 24, and one such component could include another component. For example, in some embodiments the registry 38 could be maintained as part of the repository 30.

Each user may access the system 20 via an intermediary computing device 40, e.g., a smart phone, personal computer, tablet, laptop computer, etc., having a user interface 42 that may include, e.g., a display 44, a keyboard 46, audio/voice recognition 48, etc. In various embodiments and as further described below, each specific appliance registered in the registry 38 may be user-serviced in accordance with appliance servicing instructions from the information repository 30, with guidance being provided through a user interface 42, and in some instances being responded to by the user through a user interface 42, of an intermediary computing device 40. Communications between an intermediary computing device 40 and the system 20 may be handled through a server 50. In various embodiments, the server 50 may be cloud-based. In some embodiments, the registry 38 may receive, through the server 50, specific settings and/or configurations that were entered, e.g., by the user on a specific appliance in the course of servicing the specific appliance. Such settings may be stored in the registry 38, e.g., for future reference during future servicing(s). In various embodiments, the server 50 maintains the registry 38 and user-specific settings and/or configurations.

Each intermediary computing device 40 is remotely connectable with the server 50, e.g., via the Internet 54, a cellular network 56, and/or other wide-area network. In various embodiments, a user may connect an intermediary computing device 40 with the server 50 through a home wireless network 58 and the Internet 54. In some example embodiments, a user may have one or more appliances that are wireless-capable and that may be connectable or connected with the user's home network.

An intermediary computing device 40 may include (without limitation) a mobile device such as a cellular or mobile phone, a smart phone, a Blackberry®, an Android® device, an I-Phone®, I-Pad®, tablet, notebook computer, etc., that can communicate using wireless communication, including but not limited to Wi-Fi, 802.11-based, WiMAX, Bluetooth, Zigbee, 3G, 4G, subscriber-based wireless, PCS, EDGE, and/or other wireless communication means, or substantially any combination thereof. An intermediary computing device 40 has, or has access to, a software application 60 configured to perform various functions in accordance with various implementations of the disclosure. It should be noted generally that the term “software application” is to be interpreted broadly in the present disclosure. A “software application” can take many forms, including but not limited to source, object, and/or executable codes that can include and/or refer to a plurality of objects, modules, libraries, services, etc., and that can be stored, distributed, downloaded, combined and/or accessed in many different ways.

In one example implementation, the software application 60 is loaded onto the intermediary computing device 40, e.g., by or through the server 50. The software application 60 may be written, e.g., in C++, development systems for Apple iOS, Android, etc. Implementations also are possible in which the intermediary computing device 40 uses and/or communicates through web services and/or a web browser to implement the application 60. In some implementations the application 60, and/or execution of the application 60, may be distributed, e.g., among two or more computers located, e.g., in two or more geographic locations. In some embodiments the intermediary computing device 40 may receive user input and send the input, e.g., to the server 50 or other server that has, or has access to, the application 60. Additionally or alternatively, a user may access, via browser software of an intermediary computing device 40, a website 64 that provides features of the system 20.

The system 20 may make various features available to various users based on user profile. For example, in some embodiments, an installer of appliances may be assigned a user profile that allows user access, via a website and/or software application, to various features of the system 20 that are not necessarily made available, e.g., to a homeowner who has been assigned a more restrictive user profile. Further, in some embodiments a “guest” user may be allowed access to some features of the system 20 without having to register any appliances in the system. Such users may be provided, e.g., with access to information stored in the information repository 30 for one or more appliances. Such information may be stored, e.g., in the form of on-line user manuals, maintenance manuals, installation instruction manuals, etc.

One may register as a user in the system 20, e.g., by setting up a user account and user profile in the system 20. A registered user may indicate to the system 20 that the user wishes to add to the appliance registry 38 a specific appliance associated with, e.g., owned and/or to be serviced by, the user. The user may send information identifying the specific appliance to the registry 38 via an intermediary computing device 40 and the server 50. For example, a user may enter a model number, serial number, or other identifier of a specific appliance into the user's intermediary computing device 40 and send the identifier to the registry 38 via the server 50. In some example embodiments, the identifier may, e.g., be provided by the supplier on the appliance as a bar code, QR code, etc., that may be scanned or photographed, e.g., using a camera of a user's intermediary computing device 40, e.g., a smart phone camera. Additionally or alternatively, a user may enter the identifier for an appliance via a keyboard, touch screen, and/or voice recognition capability of an intermediary computing device 40.

A given supplier may provide a group of appliances of various types, e.g., thermostats, water heaters, furnaces, etc., and various models of a given appliance type. For example, a supplier may provide several models of thermostats, e.g., programmable thermostats, touch screen thermostats, non-programmable thermostats, wireless-capable thermostats, etc. Using the identifying information sent by the user, the system 20 determines, from among various appliance types and various models of a given appliance type provided by the supplier, the specific type and model of the appliance that the user wishes to register. For example, the server 50 obtains the specific appliance type and model from the information repository 30, which in various embodiments stores appliance identification and servicing information for substantially the entire group of appliances provided by the supplier.

A user may register with the system 20 an appliance provided by the supplier, e.g., in order to have access to authoritative and current information that is specific to that appliance. In the example shown in FIG. 1, one user has registered in the registry 38 a specific furnace 70, a specific air conditioning unit 72, and a specific thermostat 74, which are all present in premises 76, e.g., the user's home or commercial location. Another user has registered in the registry 38 a specific water heater 78 that is present in the user's premises 80. It should be noted generally that various appliances may have various kinds of identifiers, which may or may not include a model number.

In various embodiments, the system 20 provides interactive guidance to users who wish to service their appliances that are registered in the system 20. Such servicing can include (without limitation) installing an appliance, configuring an appliance for operation, e.g., in a user's climate control system, selecting and setting various settings on an appliance, maintaining an appliance, trouble-shooting and diagnosing appliance conditions, etc. A user may use an intermediary computing device 40 to request guidance from the system 20 in performing a specific servicing of a specific appliance. In various embodiments, and based on the specific appliance for which the user requests such guidance, the server 50, using servicing information from the information repository 30 for the specific appliance, responds to the request by interactively providing instructions to the user by which to perform the servicing. The instructions are provided, e.g., via a display and/or speaker of the user's intermediary computing device 40.

The server 50 also solicits and may receive feedback from the user via the intermediary computing device 40, e.g., as the user is performing the specific servicing. At least two types of user feedback may be received by the system 20 as a user is servicing an appliance. As a first example, the user may respond to a request by the system 20 for information relevant to the specific appliance and/or its servicing, e.g., as to whether a specific wire, connection, setting, etc., is present, e.g., on the appliance or at the appliance location. In various embodiments, the system 20 uses feedback to such requests in real time, e.g., to determine a subsequent instruction flow to further guide the user in performing the servicing. In some embodiments, the instructions are provided to coordinate the servicing relative to other appliances, if any, present at the premises at which the specific appliance is present and that are to be taken into account and/or included in performing the servicing. For example, a user being instructed how to configure the thermostat 74 for operation in the premises 76 may be requested to input the types of heating and cooling appliances to be controlled by the thermostat 74. The configuration settings entered for the thermostat 74 by the user may be stored in the system 20 for future use. For example, in various embodiments in which a thermostat or other configurable appliance is configured for wireless communication, a user who is a homeowner may select to have configuration settings previously stored in the system 20, e.g., by an installer of the appliance, to be wirelessly pushed to the appliance to configure it for operation.

As a second example, the user may respond to a request by the system 20 for feedback, e.g., regarding the clarity and/or sufficiency of instructions and/or descriptions presented to the user on the user interface of the intermediary computing device 40, convenience (or lack thereof) in performing particular servicing step(s), etc. Additionally or alternatively, the system 20 may provide the user with a means to affirmatively send such feedback in the course of servicing an appliance. Such feedback may include, e.g., comments that a particular instruction or description was unclear or insufficient, suggestions for improving the instructions, descriptions and/or the appliance itself, questions about particular instructions or descriptions, etc. In some embodiments, the system 20 may use such feedback to provide a list of frequently asked questions and to provide answers to such questions. In various embodiments, user feedback that is generated in real time, when servicing is being performed, can provide insights and information about specific appliances, their use and surroundings, and specific difficulties that users may encounter when servicing the appliances. Such real-time information typically is not available to manufacturers and/or suppliers, unless a user's difficulty is sufficiently burdensome so as to motivate the user to call customer service. Real-time user feedback solicited during servicing can be used to improve servicing instructions provided by the system 20, and also may provide insights into how a manufacturer might improve settings and/or features of the appliances themselves. For example, user feedback to particular servicing instructions may reveal that a particular appliance component would be more convenient for users to deal with if it is relocated on the appliance. The information repository 30 can be updated as improvements are made, so that a central, authoritative source for servicing and other appliance information can be maintained.

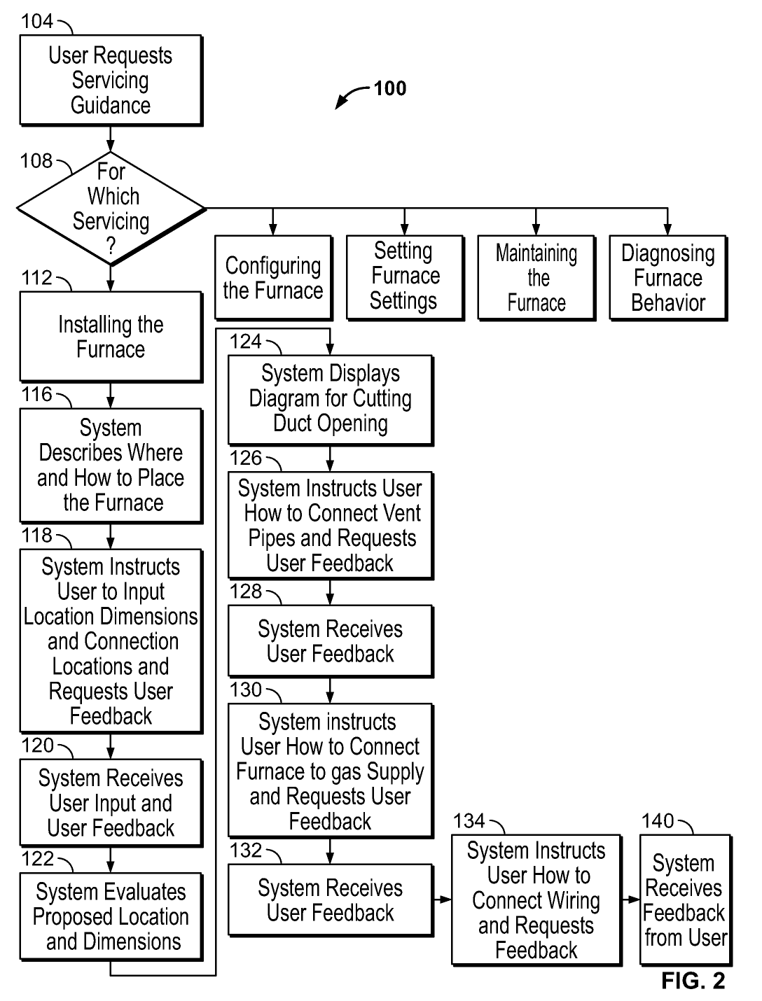

One example embodiment of a method of providing interactive guidance to users who wish to service their appliances is indicated generally in FIG. 2 by reference number 100. The method 100 is described with reference to the exemplary system 20. In process 104 a user, e.g., a contractor or owner of the premises 76, uses an intermediary computing device 40, e.g., the user's smart phone, to request guidance from the system 20 for providing a specific servicing of the gas furnace 70. In process 108 the system 20 indicates a plurality of servicing types from which the user may select a specific servicing type. In the present example, a specific servicing may be one for installing the furnace, for configuring the furnace, for setting settings for the furnace, for maintaining the furnace, and for diagnosing behavior of the furnace. It should be noted that in various embodiments, a given appliance may be serviced through other or additional types of servicing, and that a given servicing type for a given appliance may include for selection therefrom a plurality of alternative ways of servicing the appliance.

In the present example embodiment, in process 112 the user requests, via the user's smart phone, that the system 20 provide guidance for installing the gas furnace. It should be noted that the various processes described as being included in the method 100 do not necessarily address all aspects of installing a gas furnace, but are intended as examples for describing operation of the method 100. Referring again to FIG. 2, in process 116 the system 20 displays and/or describes by voice on the smart phone information and instructions relating to placement of the furnace at an appropriate location. Such information and instructions may describe, e.g., where to place the furnace appropriately in relation to gas supply, ducts, wiring and venting, how to prepare the location to receive the furnace, etc. In process 118, the system 20 instructs the user to input the dimensions of the proposed furnace location and to describe the locations of gas and other connections relative to the proposed furnace location. The system 20 also requests user feedback, e.g., as to whether the instructions were clear and as to whether the user wishes to ask a frequently asked question about the instructions. In process 120 the user may provide such information and/or may provide comments and/or questions, e.g., for clarifying the information requests by the system 20. If the user inputs a frequently asked question, the system 20 may retrieve a reply and send it to the user via the user's smart phone.

In process 122 the system 20, e.g., may use dimensions and/or other information entered by the user to recommend whether and if so, specifically where, the furnace might be installed in the proposed location. Notably, the system 20 provides instructions that are customized for the specific furnace model, in contrast to providing an assembly of instructions applicable to several furnace models and from which the user must select instructions as appropriate for the specific furnace model. Further, in various embodiments the system 20 provides a single set of instructions in a language selected by the user, in contrast to providing multiple instruction sets in various languages and through which the user may have to search for the preferred language.

In various embodiments, the system 20 may display, on the user's smart phone display, diagrams or other visual aids to guide the user in responding to requests by the system 20. In the present example, based on the user's input describing where the furnace is to be placed, in process 124 the system 20 provides the user with a diagram of the furnace cabinet showing where a return air duct should be attached to the furnace and how to cut a hole in the furnace cabinet to accommodate the return air duct. In various embodiments, the system 20 asks for user feedback after each instruction, so that system 20 might determine whether the instruction was effective to guide the user. It should be noted generally that in some embodiments, the user may utilize graphic and/or photographic capabilities of the smart phone, in addition to or in place of text and/or voice communication, e.g., to provide information requested by the system 20 or as may be considered by the user to be informative to the system 20.

In process 126 the system 20 instructs the user how to connect the furnace vent pipes. Based on the above-described spatial information entered by the user, the system 20 may display on the smart phone display the proper angles at which the pipes should be connected, and also may display how to make proper vent pipe connections. In the present example embodiment, the system 20 requests user feedback to verify that the instructions were followed and that the pipes were properly connected, and to determine whether the user encountered any difficulty in connecting them. In process 128 the user sends the requested feedback via the user's smart phone.

In process 130 the system 20 instructs the user how to connect the furnace to the gas supply. The system 20 may, e.g., display and/or speak a request to the user to verify proper operation of the furnace gas shut-off valve, to verify that the connector is appropriate and appropriately connected, to verify the absence of gas leaks, and to provide feedback to the system 20 sufficient to indicate that the connection was properly made and/or to indicate the user's opinion regarding the instructions. In process 132 the user sends the requested feedback to the system 20. In process 134 the system 20 guides the user as to how to connect the electrical wiring. In some embodiments, the system 20 displays a set of wiring connections to be made by the user and instructs the user how to make the connections. In process 140 the user makes the wiring connections as instructed and/or provides feedback to the system 20. In various embodiments, when the user has finished the furnace installation, the system 20 asks the user to perform a series of safety and operational checks and to send the results to the system 20. The system 20 compares the results to the manufacturer's recommendations and accordingly informs the user whether the furnace is properly installed.

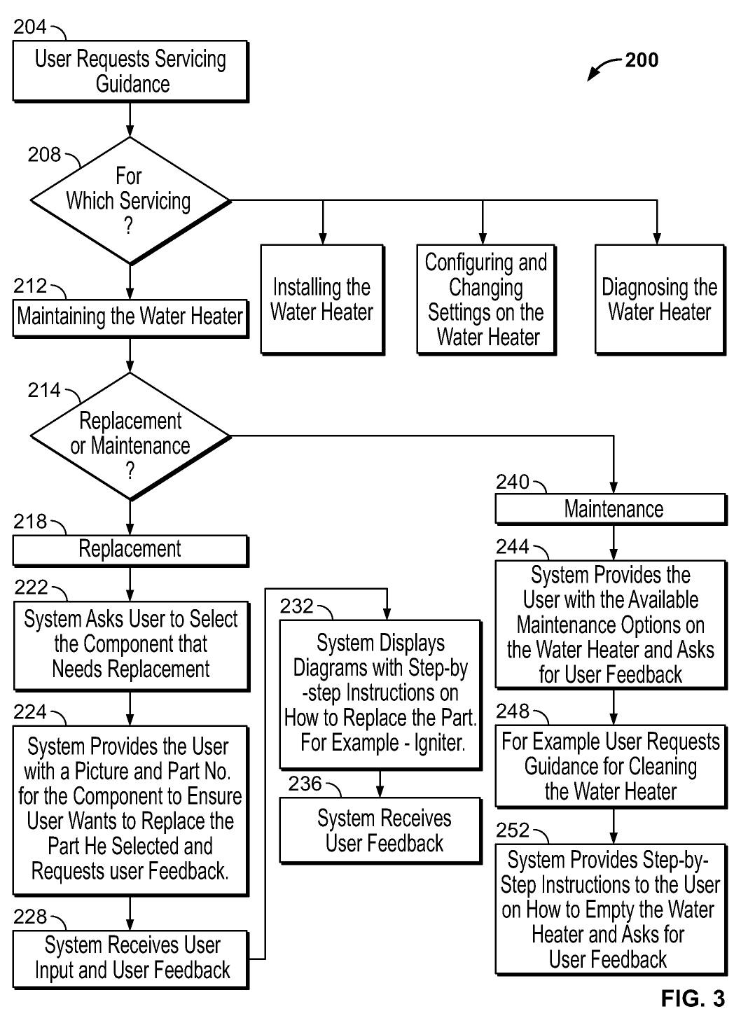

Another example embodiment of a method of providing interactive guidance to users who wish to service their appliances is indicated generally in FIG. 3 by reference number 200. The method 200 is described with reference to the exemplary system 20. In process 204 a user, e.g., a contractor or owner of the premises 80, uses an intermediary computing device 40, e.g., the user's smart phone, to request guidance from the system 20 for providing a specific servicing of the water heater 78. In process 208 the system 20 indicates a plurality of servicing types from which the user may select a specific servicing type. In the present example, a specific servicing type may be for maintaining the water heater, for installing the water heater, for configuring and changing settings on the water heater, and/or for diagnosing behavior of the water heater. It should be noted that in various embodiments, a given appliance may be serviced through other or additional types of servicing, and that a given servicing type for a given appliance may include for selection therefrom a plurality of alternative ways of servicing the appliance. Such servicing(s), and user instructions for performing such servicing(s), are customized to the specific type, model and/or other differentiator of the specific appliance.

In the present example embodiment, in process 212 the user requests, via the user's smart phone, that the system 20 provide guidance for maintaining the water heater. It should be noted that the various processes described as being included in the method 200 do not necessarily address all aspects of for maintaining a water heater, but are intended as examples for describing operation of the method 200. In process 214 the system 20 asks the user whether the user wants to replace a water heater component or to perform other maintenance on the water heater 78. If in process 218 the user selects to replace a component, in process 222 the system 20 provides a list and/or diagram(s) of components appropriate for the water heater 78 and instructs the user to indicate which component is to be replaced. The user may select a component and indicate the selection to the system 20. The user may also provide feedback to the system 20 pertaining to the instruction(s), the component, etc. In process 224 the system 20 provides the user with a picture and part number for the selected component to ensure that the user wants to replace the pictured component. The system 20 also requests user feedback, e.g., as to whether the instructions were clear and as to whether the user wishes to ask a frequently asked question about the instructions. In process 228 the user may provide such information and/or may provide comments and/or questions, e.g., for clarifying the information requests by the system 20. If the user inputs a frequently asked question, the system 20 may retrieve a reply and send it to the user via the user's smart phone.

Notably, the system 20 provides instructions that are customized for the specific water heater model and also for the specific component. The single instruction sequence is in contrast to providing a first assembly of instructions applicable to several water heater models and a second assembly of instructions applicable to several different component models, from which the user must select instructions as appropriate for both the specific water heater model and component model. Further, in various embodiments the system 20 provides a single sequence of instructions in a language selected by the user, in contrast to providing multiple instruction sets in various languages and through which the user may have to search for the preferred language.

In various embodiments, the system 20 may display, on the user's smart phone display, diagrams or other visual aids to guide the user in responding to requests by the system 20. In the example method 200, in process 232 the system 20 displays diagrams with step-by-step instructions to the user on how to replace the component, which may, e.g., be an igniter. In various embodiments, the system 20 asks for user feedback after each instruction, so that system 20 might determine whether the instruction was effective to guide the user. In the example method 200, in process 236 the user returns feedback to the system 20. It should be noted generally that in some embodiments, the user may utilize graphic and/or photographic capabilities of the smart phone, in addition to or in place of text and/or voice communication, e.g., to provide information requested by the system 20 or as may be considered by the user to be informative to the system 20.

If in process 240 the user selects to perform maintenance, in process 244 the system 20 provides a list of available maintenance options appropriate for the water heater 78 and instructs the user to indicate which maintenance option is to be performed. In process 248 the user may select a maintenance option, e.g., cleaning the water heater, and indicate the selection to the system 20. The user may also provide feedback to the system 20 pertaining to the instruction(s), the component, etc.

In the example method 200, in process 252 the system 20 displays diagrams with step-by-step instructions to the user on how to clean the water heater 78. In various embodiments, the system 20 asks for user feedback after one or more instructions, e.g., after each instruction, so that system 20 might determine whether the instruction was effective to guide the user.

Embodiments of the foregoing systems and methods provide benefits to both appliance manufacturers and users. Instruction sheets that are currently in use typically rely on the instruction sheet writer for simplicity and clarity. Generally there is no feedback on what needs to be improved in such instruction sheets. In contrast, the foregoing embodiments can provide instantaneous feedback, which can be used to improve the overall usability of servicing instructions. There is no longer a need for concern about outdated instruction sheets. Further, the real-time information obtained from users as they negotiate the steps of performing various types of servicing can provide insight into how the servicing processes can be improved. Such information can also reveal areas of possible improvements in the appliances themselves.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for use by a supplier of and users of a group of appliances, the system comprising:
at least one computer having an information repository in which appliance servicing instructions for servicing the group of appliances are stored to provide an interactive resource for guiding user servicing of any appliance of the group of appliances; and
a remote server configured to communicate with users of the appliances via user-operated intermediary computing devices, the remote server maintaining an appliance registry in which specific appliances in the group of appliances are registered and associated with specific user accounts, the remote server associating each specific registered appliance with appliance servicing instructions from the information repository for provision by the remote server on a display and/or through a speaker of one of the intermediary computing devices in response to a request from one of the intermediary computing devices for guidance in manually performing a specific servicing of the specific registered appliance;
wherein the remote server directs performance of a requested specific servicing of a given specific registered appliance, by coordinating interactive provision of a first set of appliance servicing instructions for the given specific registered appliance with interactive provision of a second set of appliance servicing instructions for servicing another specific appliance serviceable in relation to the given specific registered appliance;
the server further configured to solicit and receive, from one of the intermediary computing devices, real-time user feedback pertaining to one or more of the servicing instructions sent to the one of the intermediary computing devices, the feedback being solicited and received in the course of user-performed servicing for one of the specific registered appliances;
wherein the appliance servicing instructions are updatable in the information repository based on the user feedback.

2. The system of claim 1, wherein the remote server directs the performance of the requested specific servicing, by coordinating the instructions relative to spatial dimensions present at the premises at which the specific registered appliance is present, the dimensions being provided interactively via the intermediary computing device, and that are to be taken into account and/or included in performing the servicing.

3. The system of claim 1, wherein the remote server directs the performance of the requested specific servicing relative to a climate control system at the premises at which the specific registered appliance is present.

4. The system of claim 1, wherein the intermediary computing device comprises one of the following: a smart phone, a personal computer, a tablet, and a laptop computer.

5. The system of claim 1, wherein a servicing for an appliance comprises one or more of the following: installing the appliance, configuring the appliance, setting settings on the appliance, operating the appliance, diagnosing the appliance, and maintaining the appliance.

6. The system of claim 1, wherein the server and intermediary computing device communicate via one or more of the following: a software application, and a website.

7. The system of claim 1, wherein the server is programmed to maintain, for each of the users, setting and/or configuration preferences, if any, of the user as to one or more appliances maintained in the registry for the user.

8. The system of claim 1, wherein the appliances provided by the supplier comprise one or more of the following: thermostats, water heaters, ignition controls, cooling controls, defrost controls, gas valves, furnace controls, air conditioners, and climate control appliances.

9. A system for use by a supplier of and users of a group of appliances, the system comprising:
at least one computer having an information repository maintained by a supplier of appliances; and
a remote server connected with the information repository and maintaining a registry in which are registered, for each of a plurality of user accounts, one or more specific appliances provided by the supplier, associated with the user account, and for which appliance servicing information is maintained in the information repository;
the server further configured to receive, via a user-operated intermediary computing device, a user request for guidance in manually performing a specific requested servicing for a given specific appliance associated in the registry with the user, in response to which the server provides substantially real-time guidance therefor on a display and/or speaker of the intermediary computing device;
wherein the server dynamically directs the performance by providing one or more instructions incorporating servicing information maintained in the information repository for the given specific appliance, and coordinates the instructions for the specific requested servicing with instructions pertaining to other appliances, if any, present at the premises where the specific requested servicing is being performed and that are to be taken into account and/or included in the specific requested servicing;
the server further configured to, pertinent to one or more of the instructions, solicit and receive user feedback via the intermediary computing device in the course of user performance of the specific requested servicing.

10. The system of claim 9, wherein the given specific appliance is configured for wireless communication and the specific requested servicing comprises configuring the given specific appliance for operation in relation to the other appliances at the premises; wherein the server wirelessly transmits configuration parameters for the other appliances to the given specific appliance.

11. The system of claim 9, wherein the specific servicing comprises one or more of the following: installing the specific appliance, configuring the specific appliance, setting settings on the specific appliance, operating the specific appliance, diagnosing the specific appliance, and maintaining the specific appliance.

12. The system of claim 9, wherein the server maintains in the registry, for each of the user accounts, setting and/or configuration preferences, if any, of the user as to one or more specific appliances registered in the registry for the user account.

13. The system of claim 9, wherein the server and intermediary computing device communicate via one or more of the following: a software application, and a website.

14. The system of claim 9, wherein the group of appliances comprises one or more of the following: thermostats, water heaters, ignition controls, cooling controls, defrost controls, gas valves, furnace controls, air conditioners, and climate control appliances.

15. The system of claim 9, wherein to coordinate instructions for the specific requested servicing with instructions pertaining to other appliances comprises to coordinate the specific requested servicing relative to a climate control system at the premises.

16. The system of claim 9, wherein the intermediary computing device comprises one of the following: a smart phone, a personal computer, a tablet, and a laptop computer.

17. A computer-performed method of interactively guiding a user to service an appliance, the method comprising:
a server receiving and storing an association of a specific appliance with a specific user account in a registry of appliances, the registry maintained by the server and provided by a supplier of the appliances;
the server receiving a request, from a user-operated intermediary computing device remote from the server, for interactive guidance in user-servicing of the specific appliance;
in response to the request, the server retrieving servicing instructions for a specific servicing of the specific appliance from an information repository residing on at least one computer and in which servicing instructions for servicing the appliances provided by the supplier are stored to provide an interactive resource for guiding user servicing of appliances registered in the registry; and
the server providing, on a display and/or through a speaker of the intermediary computing device, the servicing instructions for the specific servicing;
wherein the server, to direct a manual performance of the specific servicing, dynamically coordinates interactive provision of a first set of appliance servicing instructions for the specific appliance with interactive provision of a second set of appliance servicing instructions for another appliance to be serviced in the course of servicing the specific appliance;
the server soliciting and receiving, from the intermediary computing device, real-time user feedback pertaining to one or more of the servicing instructions sent to the intermediary computing device, the feedback being solicited and received between user performance of consecutive ones of the servicing instructions; and
updating the servicing instructions for the specific appliance in the information repository based on the user feedback.

18. The method of claim 17, wherein the servicing instructions for the specific appliance include instructions for performing one or more of the following: installing the specific appliance, configuring the specific appliance, setting settings on the specific appliance, operating the specific appliance, diagnosing the specific appliance, and maintaining the specific appliance.

19. The method of claim 17, wherein the intermediary computing device comprises one of the following: a smart phone, a personal computer, a tablet, and a laptop computer.

20. The method of claim 17, further comprising the server maintaining, for a given user account, setting and/or configuration preferences, if any, of the user as to one or more specific appliances registered in the registry for the given user account.
